(19) United States
(12) Patent Application Publication
(10) Pub. No.: US 2025/0135932 A1
(43) Pub. Date: May 1, 2025

(54) CHARGING ROBOT, CONTROL SERVER, AND CHARGING METHOD

(71) Applicants: HYUNDAI MOTOR COMPANY, SEOUL (KR); KIA CORPORATION, SEOUL (KR)

(72) Inventors: Jung Min Ryu, Hwaseong-si (KR); Jae Hag Jung, Seoul (KR); Dae Yong Kim, Gwangju-si (KR); Deuk Jun Kim, Suwon-si (KR); Chan Mo Lim, Suwon-si (KR); Myung Hwa Ji, Suwon-si (KR)

(21) Appl. No.: 18/610,834

(22) Filed: Mar. 20, 2024

(30) Foreign Application Priority Data
Nov. 1, 2023 (KR) 10-2023-0149230

(51) Int. Cl. B60L 53/36; B60L 53/66; G01S 17/93; H02J 7/00

(52) U.S. Cl. CPC B60L 53/36; B60L 53/66; G01S 17/93; H02J 7/0042

(57) ABSTRACT

A charging robot includes a memory storing computer-executable instructions, at least one processor that accesses the memory and executes the instructions, an output device, and a first position recognition device that identifies a vehicle approaching a charging specification. The processor determines at least one of a first distance between the vehicle identified by means of the first position recognition device and the charging robot, a first movement direction of the vehicle, or a first movement speed of the vehicle, or any combination thereof and charges the vehicle, based on that a position of the vehicle is included in a charging position which is a position at which the charging robot is able to charge the vehicle, based on the at least one of the first distance, the first movement direction, or the first movement speed, or the any combination thereof.

### CROSS REFERENCE TO RELATED APPLICATIONS

This application claims the benefit of priority to Korean Patent Application No. 10-2023-0149230, filed in the Korean Intellectual Property Office on Nov. 1, 2023, the entire contents of which are incorporated herein by reference.

### TECHNICAL FIELD

The present disclosure relates to a charging robot, a control server, and a charging method, and more particularly, relates to technologies of charging a vehicle by means of the charging robot without an alighting operation of a driver, in the process of charging the vehicle.

### BACKGROUND

With carbon emission control policies, the automobile industry has been required to increase fuel efficiency and reduce carbon emissions for petroleum-based vehicles. Thus, an electric vehicle which is driven by electricity and does not generate exhaust gas has been developed in various forms.

An electric vehicle and an electric vehicle charging station have been expanded. There has been the inconvenience of a driver who drives a corresponding vehicle type. For example, there is application interworking payment when an electric vehicle is charged, payment using a robot, or the like. However, this should perform an operation in which a driver inputs charging information and performs payment after alighting from the electric vehicle. To this end, there is a need for an interworking configuration for an electric vehicle charging robot, a driver, an electric vehicle, a payment system, an infrastructure (e.g., a CCTV), and a control system to provide a smooth service.

To address such a problem, there is a need to develop a technology for recognizing a position of a vehicle, charging the vehicle, when the position of the vehicle is a charging position, recognizing a position of an obstacle in a safe area to stop charging the vehicle, and paying a charging fee by means of recognition information obtained by identifying the vehicle.

### SUMMARY

The present disclosure has been made to solve the above-mentioned problems occurring in the prior art while advantages achieved by the prior art are maintained intact.

An aspect of the present disclosure provides a charging robot for charging a vehicle based on that the position of the vehicle identified by means of a first position recognition device is included in a charging position and determining an entry speed and an expected position of the vehicle which moves for charging, without the necessity of a CCTV for identifying a parking state of the vehicle, to prevent an accident through a warning alarm, a control server, and a charging method.

Another aspect of the present disclosure provides a charging robot for stopping charging a vehicle based on that the position of an obstacle identified by means of a second position recognition device is located in a safe area, such that there is no need to install a separate motion sensor bollard for obstacle detection for identifying an obstacle, a control server, and a charging method.

Another aspect of the present disclosure provides a charging robot for transmitting charging data to a vehicle, based on communication data identified by means of recognition information for identifying the vehicle, such that there is no need to install a separate application by using convenience capable of paying a charging fee without the alighting of the driver and an audio, video, navigation (AVN) system included in the vehicle, a control server, and a charging method.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a charging robot may include a memory storing computer-executable instructions, at least one processor that accesses the memory and executes the instructions, an output device, and a first position recognition device that identifies a vehicle approaching a charging specification. The at least one processor may determine at least one of a first distance between the vehicle identified by means of the first position recognition device and the charging robot, a first movement direction of the vehicle, or a first movement speed of the vehicle, or any combination thereof and may charge the vehicle, based on that a position of the vehicle is included in a charging position which is a position at which the charging robot is able to charge the vehicle, based on the at least one of the first distance, the first movement direction, or the first movement speed, or the any combination thereof.

In an embodiment, the at least one processor may determine the first distance, based on the result of communication between a tag capable of being included in the vehicle and identifying the position of the vehicle and an anchor of an ultra-wideband (UWB) sensor included in the first position recognition device, on the basis of a target time point when the vehicle is identified by means of the first position recognition device, may determine the first movement direction, based on the position of the vehicle, and may determine the first movement speed, based on the first distance and the first movement direction.

In an embodiment, the at least one processor may determine a position of the vehicle at a subsequent time point subsequent to the target time point, based on a position of the vehicle at the target time point when the vehicle is identified by means of the first position recognition device, a first movement speed at the target time point, a first movement speed of a preceding time point preceding the target time point, and acceleration of the vehicle at the target time point, and may transmit a request notification for requesting to move the vehicle, through at least one of the output device or an output device included in the charging station, or any combination thereof, based on that the position of the vehicle at the subsequent time point is located in an area different from a charging area including the charging position.

In an embodiment, the at least one processor may transmit a request notification for requesting to move the vehicle, through at least one of the output device or an output device included in the charging station, or any combination thereof, based on comparing acceleration of the vehicle at the target time point with predetermined acceleration.

In an embodiment, the at least one processor may identify that the position of the vehicle is located at the charging position, based on comparing the first distance with a predetermined distance available for charging, and may charge the vehicle, based on that the position of the vehicle is located at the charging position.

In an embodiment, the at least one processor may transmit a request notification for requesting to move the vehicle, through at least one of the output device or an output device included in the charging station, or any combination thereof, based on that it is identified that the position of the vehicle is not located at the charging position.

In an embodiment, the charging robot may further include a second position recognition device that identifies an obstacle located in a predetermined area based on the position of the vehicle. The at least one processor may determine a safe area corresponding to an identification area of the second position recognition device, based on that the position of the vehicle is included in the charging position, may determine at least one of a second distance between the obstacle identified by means of the second position recognition device and the vehicle, a second movement direction of the obstacle, or a second movement speed of the obstacle, or any combination thereof, based on that a position of the obstacle is located in the safe area, and may stop charging the vehicle, based on the at least one of the second distance, the second movement direction, or the second movement speed, or the any combination thereof.

In an embodiment, the at least one processor may identify recognition information including information of the vehicle, by means of a light detection and ranging (LiDAR) sensor included in the second position recognition device.

In an embodiment, the at least one processor may skip the stop of the charging of the vehicle and charges the vehicle, based on that the second movement speed is less than or equal to a predetermined first threshold speed.

In an embodiment, the at least one processor may stop charging the vehicle, based on that the second movement speed is greater than or equal to a predetermined second threshold speed and that the second movement direction corresponds to a direction of the position of the vehicle from the position of the obstacle, and may transmit a stop notification for stopping charging the vehicle, through at least one of the output device or an output device included in the charging station, or any combination thereof.

In an embodiment, the at least one processor may identify the vehicle by means of the second position recognition device and may stop charging the vehicle, based on that it is identified that a door of the vehicle is open.

According to another aspect of the present disclosure, a control server may include a memory storing computer-executable instructions, at least one processor that accesses the memory and executes the instructions, and a communication device that performs communication with a charging robot and a vehicle. The at least one processor may receive recognition information for identifying the vehicle, from the charging robot, may identify communication data for performing long term evolution (LTE) communication with the vehicle, based on that information of the vehicle is queried by means of the received recognition information, and may transmit charging data, received from the charging robot, to the vehicle, based on the communication data.

According to another aspect of the present disclosure, a charging method may include determining at least one of a first distance between a vehicle identified by means of a first position recognition device included in a charging robot and the charging robot, a first movement direction of the vehicle, or a first movement speed of the vehicle, or any combination thereof, charging the vehicle, based on that a position of the vehicle is included in a charging position which is a position at which the charging robot is able to charge the vehicle, based on the at least one of the first distance, the first movement direction, or the first movement speed, or the any combination thereof, determining a safe area corresponding to an identification area of a second position recognition device included in the charging robot, based on that the position of the vehicle is included in the charging position, determining at least one of a second distance between an obstacle identified by means of the second position recognition device and the vehicle, a second movement direction of the obstacle, or a second movement speed of the obstacle, or any combination thereof, based on that a position of the obstacle is located in the safe area, and stopping charging the vehicle, based on the at least one of the second distance, the second movement direction, or the second movement speed, or the any combination thereof.

In an embodiment, the charging of the vehicle may include determining the first distance, based on the result of communication between a tag capable of being included in the vehicle and identifying the position of the vehicle and an anchor of an ultra-wideband (UWB) sensor included in the first position recognition device, on the basis of a target time point when the vehicle is identified by means of the first position recognition device, determining the first movement direction, based on the position of the vehicle, determining the first movement speed, based on the first distance and the first movement direction, determining a position of the vehicle at a subsequent time point subsequent to the target time point, based on a position of the vehicle at the target time point when the vehicle is identified by means of the first position recognition device, a first movement speed at the target time point, a first movement speed of a preceding time point preceding the target time point, and acceleration of the vehicle at the target time point, and transmitting a request notification for requesting to move the vehicle, through at least one of an output device included in the charging robot or an output device included in a charging position, or any combination thereof, based on the position of the vehicle at the subsequent time point is located in an area different from a charging area including the charging position.

In an embodiment, the transmitting of the request notification for requesting to move the vehicle may include transmitting the request notification for requesting to move the vehicle, through the at least one of the output device or the output device included in the charging station, or the any combination thereof, based on comparing the acceleration of the vehicle at the target time point with predetermined acceleration.

In an embodiment, the charging of the vehicle may include identifying that the position of the vehicle is located at the charging position, based on comparing the first distance with a predetermined distance available for charging, charging the vehicle, based on that the position of the vehicle is located at the charging position, and transmitting a request notification for requesting to move the vehicle, through at least one of an output device included in the charging robot or an output device included in a charging station, or any combination thereof, based on that it is identified that the position of the vehicle is not located at the charging position.

In an embodiment, the stopping of the charging of the vehicle may include skipping the stop of the charging of the vehicle and charging the vehicle, based on that the second movement speed is less than or equal to a predetermined first threshold speed.

In an embodiment, the stopping of the charging of the vehicle may include stopping charging the vehicle, based on that the second movement speed is greater than or equal to a predetermined second threshold speed and that the second movement direction corresponds to a direction of the position of the vehicle from the position of the obstacle, and transmitting a stop notification for stopping charging the vehicle, through at least one of an output device included in the charging robot or an output device included in a charging station, or any combination thereof.

In an embodiment, the stopping of the charging of the vehicle may include identifying the vehicle by means of the second position recognition device and stopping charging the vehicle, based on that it is identified that a door of the vehicle is open.

In an embodiment, the charging method may further include receiving recognition information for identifying the vehicle, from the charging robot, identifying communication data for performing long term evolution (LTE) communication with the vehicle, based on that information of the vehicle is queried by means of the received recognition information, and transmitting charging data, received from the charging robot, to the vehicle, based on the communication data.

### BRIEF DESCRIPTION OF THE FIGURES

The above and other objects, features and advantages of the present disclosure will be more apparent from the following detailed description taken in conjunction with the accompanying drawings:

FIG. 1 is a drawing illustrating a charging robot according to an embodiment of the present disclosure;

FIG. 2 is a flowchart for describing a method for charging a vehicle by means of a first position recognition device and stopping charging the vehicle by means of a second position recognition device, in a charging robot according to an embodiment of the present disclosure;

FIG. 3 is a drawing illustrating a connection relationship among a charging robot, a control server, and a vehicle according to an embodiment of the present disclosure;

FIGS. 4A and 4B are drawings illustrating operations performed to charging a vehicle or stop charging the vehicle, in a charging robot and a control server according to an embodiment of the present disclosure;

FIG. 5 is a drawing illustrating a method for recognizing a vehicle by means of a first position recognition device, in a charging robot according to an embodiment of the present disclosure;

FIG. 6 is a drawing illustrating a method for recognizing an obstacle by means of a second position recognition device, in a charging robot according to an embodiment of the present disclosure;

FIGS. 7A and 7B are flowcharts for describing operations performed to charging a vehicle or stop charging the vehicle, in a charging robot and a control server according to an embodiment of the present disclosure;

FIG. 8 is a drawing illustrating information capable of being displayed in a vehicle, as a charging robot transmits charging data to the vehicle, according to an embodiment of the present disclosure; and

FIG. 9 is a drawing illustrating a computing system associated with a charging robot, a control server, or a charging method according to an embodiment of the present disclosure.

With regard to description of drawings, the same or similar denotations may be used for the same or similar components.

### DETAILED DESCRIPTION

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure. Hereinafter, various embodiments of the present disclosure may be described with reference to the accompanying drawings. However, it should be understood that this is not intended to limit the present disclosure to specific implementation forms and includes various modifications, equivalents, and/or alternatives of embodiments of the present disclosure. With regard to description of drawings, similar components may be marked by similar reference numerals.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application. For example, the terms, such as “first”, “second”, “1st”, “2nd”, or the like used in the present disclosure may be used to refer to various components regardless of the order and/or the priority and to distinguish one component from another component, but do not limit the components. For example, a first user device and a second user device indicate different user devices, irrespective of the order and/or priority. For example, without departing the scope of the present disclosure, a first component may be referred to as a second component, and similarly, a second component may be referred to as a first component.

In the present disclosure, the expressions “have”, “may have”, “include” and “comprise”, or “may include” and “may comprise” indicate existence of corresponding features (e.g., components such as numeric values, functions, operations, or parts), but do not exclude presence of additional features.

It will be understood that when a component (e.g., a component) is referred to as being “(operatively or communicatively) coupled with/to” or “connected to” another component (e.g., a second component), it can be directly coupled with/to or connected to the other component or an intervening component (e.g., a third component) may be present. In contrast, when a component (e.g., a first component) is referred to as being “directly coupled with/to” or “directly connected to” another component (e.g., a second component), it should be understood that there is no intervening component (e.g., a third component).

According to the situation, the expression “configured to” used in the present disclosure may be used exchangeably with, for example, the expression “suitable for”, “having the capacity to”, “designed to”, “adapted to”, “made to”, or “capable of”.

The term “configured to” must not mean only “specifically designed to” in hardware. Instead, the expression “a device configured to” may mean that the device is “capable of” operating together with another device or other parts. For example, a “processor configured to perform A, B, and C” may mean a generic-purpose processor (e.g., a central processing unit (CPU) or an application processor) which may perform corresponding operations by executing one or more software programs which store a dedicated processor (e.g., an embedded processor) for performing a corresponding operation or a memory device. Terms used in the present disclosure are used to only describe specified embodiments and are not intended to limit the scope of another embodiment. The terms of a singular form may include plural forms unless the context clearly indicates otherwise. All the terms used herein, which include technical or scientific terms, may have the same meaning that is generally understood by a person skilled in the art described in the present disclosure. It will be further understood that terms, which are defined in a dictionary and commonly used, should also be interpreted as is customary in the relevant related art and not in an idealized or overly formal detect unless expressly so defined herein in various embodiments of the present disclosure. In some cases, even though terms are terms which are defined in the specification, they may not be interpreted to exclude embodiments of the present disclosure.

In the present disclosure, the expressions “A or B”, “at least one of A or/and B”, or “one or more of A or/and B”, and the like may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, in describing an embodiment of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. Particularly, the phrase such as “at least one of A, B, or C, or any combination thereof” may include “A”, “B”, or “C”, or “AB” or “ABC”, which is a combination thereof.

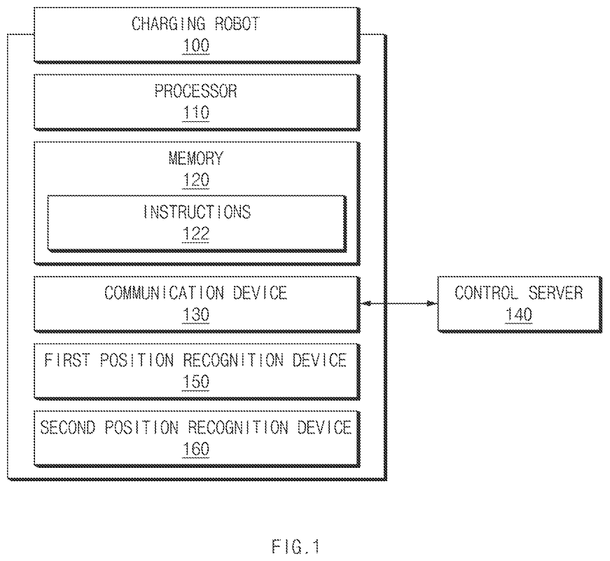

Hereinafter, embodiments of the present disclosure will be described in detail with reference to FIGS. 1 to 9.

FIG. 1 is a drawing illustrating a charging robot according to an embodiment of the present disclosure.

A charging robot 100 according to an embodiment may include a processor 110, a memory 120 including instructions 122, a communication device 130, a first position recognition device 150, and a second position recognition device 160.

The charging robot 100 may include a robot for charging a vehicle. In detail, the charging robot 100 may identify the vehicle by means of the first position recognition device 150. The charging robot 100 may determine a distance between the identified vehicle and the charging robot 100, a movement direction of the vehicle, and a movement speed of the vehicle. The charging robot 100 may determine a position of the vehicle, based on the distance between the vehicle and the charging robot 100, the movement direction of the vehicle, and the movement speed of the vehicle. When the determined position of the vehicle is included in a charging position, the charging robot 100 may charge the vehicle.

The charging robot 100 may include a robot for charging the vehicle and simultaneously stopping charging the vehicle. For example, the charging robot 100 may identify an obstacle located around the vehicle which is being charged, by means of the second position recognition device 160. The charging robot 100 may determine a safe area. Herein, the safe area may include an area where the vehicle is charged and an area disposed apart from the area at a predetermined distance. When the position of the obstacle is located in the safe area, the charging robot 100 may stop charging the vehicle. In detail, the charging robot 100 may determine a distance between the obstacle and the vehicle, a movement direction of the obstacle, and a movement speed of the obstacle. The charging robot 100 may stop charging the vehicle, based on the distance between the obstacle and the vehicle, the movement direction of the obstacle, and the movement speed of the obstacle.

The processor 110 may execute software and may control at least one other component (e.g., a hardware or software component) connected with the processor 110. In addition, the processor 110 may perform a variety of data processing or calculation. For example, the processor 110 may store the distance between the vehicle and the charging robot 100, the movement direction of the vehicle, the movement speed of the vehicle, the distance between the obstacle and the vehicle, the movement direction of the obstacle, and the movement speed of the obstacle in the memory 120.

For reference, the processor 110 may perform all operations performed by the charging robot 100. Therefore, for convenience of description in the specification, the operation performed by the charging robot 100 is mainly described as an operation performed by the processor 110. Furthermore, for convenience of description in the specification, the processor 110 is mainly described as, but not limited to, one processor. For example, the charging robot 100 may include at least one processor. Each of the at least one processor may perform all operations associated with an operation of charging the vehicle or stopping charging the vehicle.

The memory 120 may temporarily and/or permanently store various pieces of data and/or information required to perform the operation of charging the vehicle or stopping charging the vehicle. For example, the memory 120 may store the distance between the vehicle and the charging robot 100, the movement direction of the vehicle, the movement speed of the vehicle, the distance between the obstacle and the vehicle, the movement direction of the obstacle, and the movement speed of the obstacle.

The communicate device 130 may assist in performing communication between the charging robot 100 and the control server 140. For example, the communication device 130 may include one or more components for performing communication between the charging robot 100 and the control server 140. For example, the communication device 130 may include a short range wireless communication unit, a microphone, or the like. At this time, a short range communication technology may be, but is not limited to, a wireless LAN (Wi-Fi), Bluetooth, ZigBee, Wi-Fi Direct (WFD), ultra-wideband (UWB), infrared data association (IrDA), Bluetooth low energy (BLE), near field communication (NFC), or the like.

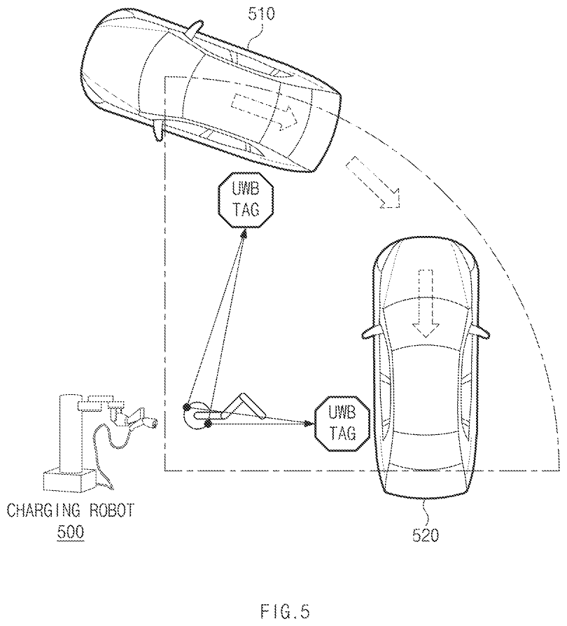

The first position recognition device 150 may recognize a position of the vehicle approaching a charging station. For example, the first position recognition device 150 may include sensors for receiving at least one signal. In detail, the first position recognition device 150 may include at least one of a sensor for receiving a global positioning system (GPS) signal, a sensor for receiving an ultrasonic signal, a sensor for receiving an infrared signal, or a sensor for receiving an ultra-wideband (UWB) signal, or any combination thereof. For reference, the UWB signal is a signal using a frequency band of at least 1 GHz or more in the baseband, without using a radio frequency (RF) carrier. Because such a UWB signal uses a very narrower pulse than pulses of the above-mentioned signals, it has an excellent penetrability. Thus, for convenience of description in the specification, the first position recognition device 150 is mainly described as a device which recognizes a position of the vehicle by means of the UWB signal. A detailed description about the method for recognizing the position of the vehicle by means of the first position recognition device 150 in the charging robot 100 will be described below with reference to FIG. 5.

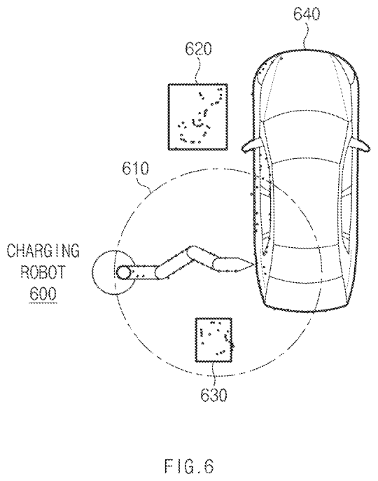

The second position recognition device 160 may include a sensor for recognizing a position of an obstacle approaching the charging station. For example, the second position recognition device 160 may include a light detection and ranging (LiDAR) sensor. The second position recognition device 160 may be a LiDAR sensor which is a sensor for beam steering for radiating laser light to a target point, which may recognize a position of the obstacle. However, the target which is recognized in position by the second position recognition device 160 is not limited thereto. For example, the second position recognition device 160 may recognize movement of the vehicle which is being charged in the charging vehicle. A detailed description about the method for recognizing the position of the obstacle by means of the second position recognition device 160 in the charging robot 100 will be described below with reference to FIG. 6.

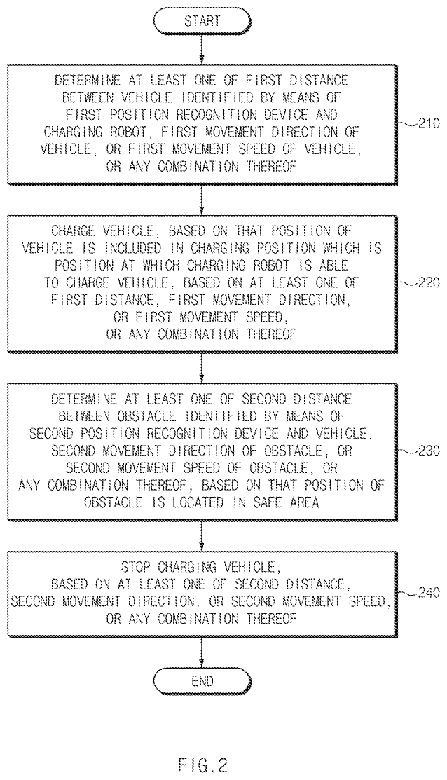

FIG. 2 is a flowchart for describing a method for charging a vehicle by means of a first position recognition device and stopping charging the vehicle by means of a second position recognition device, in a charging robot according to an embodiment of the present disclosure.

In operation 210, a charging robot (e.g., a charging robot 100 of FIG. 1) according to an embodiment may determine at least one of a first distance between a vehicle identified by means of a first position recognition device (e.g., a first position recognition device 150 of FIG. 1) and the charging robot, a first movement direction of the vehicle, or a first movement speed of the vehicle, or any combination thereof.

For example, the charging robot may identify the vehicle by means of the first position recognition device. The charging robot may determine the first distance on the basis of a target time point when the vehicle is identified. In detail, the charging robot may determine the first distance, based on the result of communication between a tag included in the vehicle and an anchor included in the first position recognition device. The charging robot may determine the first movement direction and the first movement speed, based on that the first distance is determined. A detailed description of determining the first movement direction and the first movement speed will be given below with reference to FIG. 5.

In operation 220, the charging robot may charge the vehicle. For example, the charging robot may charge the vehicle, based on that the position of the vehicle is included in a charging position which is a position at which the charging robot is able to charge the vehicle, based on the at least one of the first distance, the first movement direction, or the first movement speed, or the any combination thereof.

In operation 230, the charging robot may determine at least one of a second distance between an obstacle identified by means of a second position recognition device and the vehicle, a second movement direction of the obstacle, or a second movement speed of the obstacle, or any combination thereof, based on that the position of the obstacle is located in a safe area. For example, the charging robot may determine the safe area corresponding to an identification area of the second position recognition device, based on the position of the vehicle is included in the charging position.

In operation 240, the charging robot may stop charging the vehicle. For example, the charging robot may stop charging the vehicle, based on the at least one of the second distance, the second movement direction, or the second movement speed, or the any combination thereof.

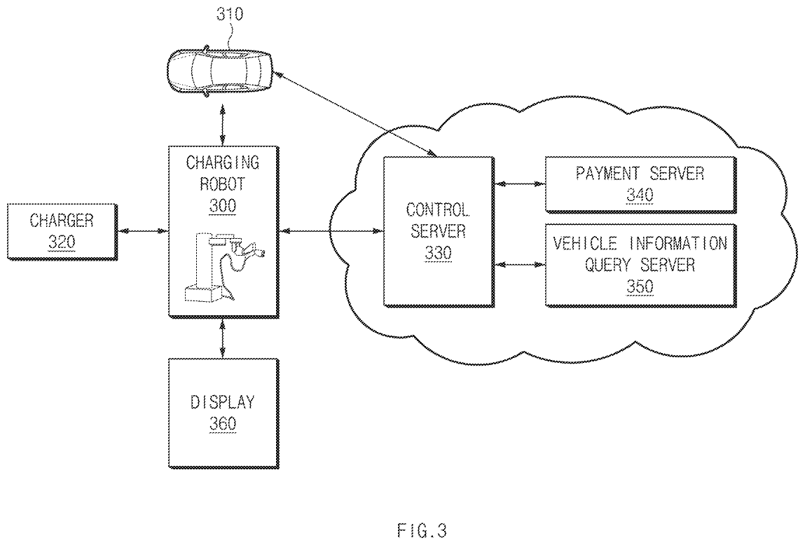

FIG. 3 is a drawing illustrating a connection relationship among a charging robot, a control server, and a vehicle according to an embodiment of the present disclosure.

A charging robot 300 according to an embodiment may perform communication with at least one external device to be connected with the at least one external device. For example, the charging robot 300 may perform communication with a vehicle 310, a charger 320, and a control server 330.

The charging robot 300 may couple a charging port of the charger 320 to a charging inlet of the vehicle 310 to charge the vehicle 310. The charging robot 300 may couple the charging port of the charger 320 to the charging inlet of the vehicle 310, based on that the position of the vehicle 310 is included in a charging position which is a position at which the charging robot 300 is able to charge the vehicle 310, based on at least one of a first distance, a first movement direction, or a first movement speed, or any combination thereof.

A driver may charge the vehicle 310 without alighting from the vehicle 310, through an interworking process between the charging robot 300 and the vehicle 310 by means of a UWB technology. Furthermore, the charging robot 300 may ensure the safety of the vehicle 310 in a process in which the vehicle 310 enters a charging station, by means of the UWB technology. A detailed description associated with it will be given below with reference to FIG. 5.

The vehicle 310 may indicate, for example, an electric vehicle which is driven by electricity and does not generate exhaust gas. In detail, the vehicle 310 may include an electric vehicle which does not include an internal combustion engine. Furthermore, the vehicle 310 may include a hybrid vehicle capable of including an internal combustion engine and being driven by electricity. Therefore, the vehicle 310 in the specification is a concept including any means of transportation or operation which is driven using electrical energy, which is not a concept bound by the number of wheels or shapes of the wheels. Furthermore, the vehicle 310 is not limited to four wheels, which may include two wheels, three wheels, or the like.

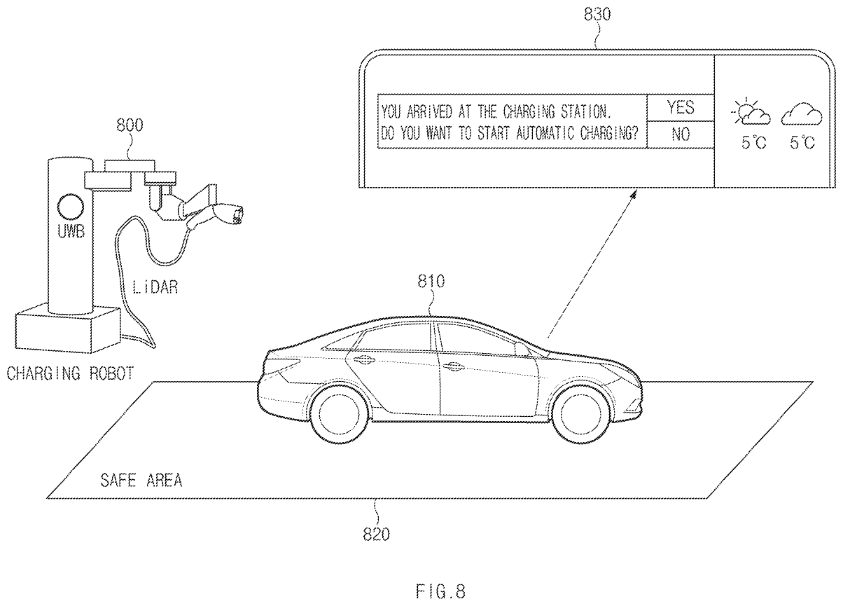

The vehicle 310 may include a tag capable of being identified by a UWB sensor. For example, the vehicle 310 may include at least one UWB tag. The UWB tag included in the vehicle 310 may be located at the charging inlet of the vehicle 310, but not limited thereto. Furthermore, the vehicle 310 may include an AVN system capable of receiving an input of the driver. The vehicle 310 may provide the driver with payment about charging, by means of the AVN system. A detailed description associated with it will be given below with reference to FIG. 8.

The charger 320 may indicate a device which charges a battery included in the vehicle 310. Therefore, the charging in the specification may collectively refer to a process of supplying power to the battery of the vehicle 310 such that the vehicle 310 is able to be driven and may be classified as a quick charge, a slow charge, a non-contact charge, or the like in conjunction with a time taken for charging or a charging scheme. However, the charging in the present disclosure may be applied to all of the above-mentioned classifications.

The control server 330 may indicate a server for interworking and integrated management with the charging robot 300, the vehicle 310, the payment server 340, a vehicle information query server 350, a camera, and the like. For example, the control server 330 may perform communication with the charging robot 300 through a KAFKA (e.g., Apache Kafka) communication protocol. The control server 330 may perform communication with the vehicle 310 through a long term evolution (LTE) protocol. The control server 330 may perform communication with each of the payment server 340 and the vehicle information query server 350 through a representational state transfer API (RESTAPI) communication protocol.

The control server 330 may include a memory for storing computer-executable instructions, at least one processor for accessing the memory and executing the computer-executable instructions, and a communication device for performing communication with external devices such as the charging robot 300 and the vehicle 310. The control server 330 may receive recognition information for identifying the vehicle 310 from the charging robot 300. The control server 330 may identify communication data for performing long term evolution (LTE) communication with the vehicle 310, based on that information of the vehicle 310 is queried by means of the received recognition information. The control server 330 may transmit the charging data, received from the charging robot 300, to the vehicle 310, based on the communication data. Herein, the charging data may include, but is not limited to, charging verification data, payment information data, charging port opening command data, charging port closing command data, and the like.

The payment server 340 may indicate a server for performing communication with a card company of a card on which the driver performs payment. For example, the payment server 340 may transmit the charging data received from the control server 330 to a card company server to perform payment of the driver. The payment server 340 may perform the payment of the driver by means of the charging data to perform charging payment without the alighting of the driver.

The vehicle information query server 350 may indicate a server for obtaining identification information necessary for communication with the vehicle 310. For example, the vehicle information query server 350 may be a Bluelink server, which may include a server which provides a telematics service capable of operating by a vehicle manufacturer. In detail, the vehicle information query server 350 may receive the recognition information of the vehicle 310 identified by means of the second position recognition device of the charging robot 300 from the control server 330. The vehicle information query server 350 may query a previously stored database for the received recognition information to identify a characteristic (e.g., a manufacturer, a model, a charging capacity, a model year, and the like) of the vehicle 310. The vehicle information query server 350 may transmit data about communication approval to the control server 330, based on that the information of the vehicle 310 is queried by means of the recognition information. The vehicle information query server 350 may identify the characteristic of the vehicle by means of the recognition information of the vehicle 310 to authenticate the vehicle 310 without the alighting of the driver.

The display 360 may indicate a display provided by a charging station. For example, the display 360 may output a charging state of the vehicle 310, a request notification for requesting to move the vehicle 310, a stop notification for stopping charging the vehicle 310, and the like.

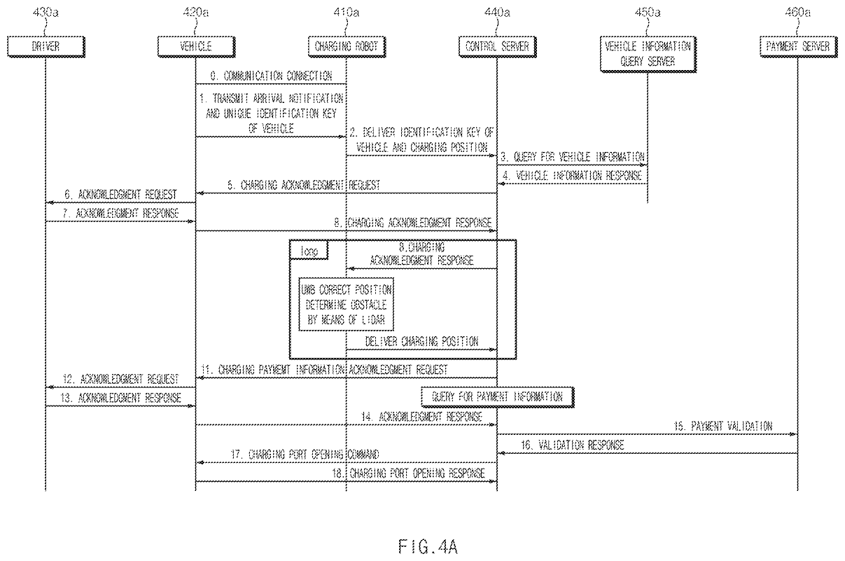

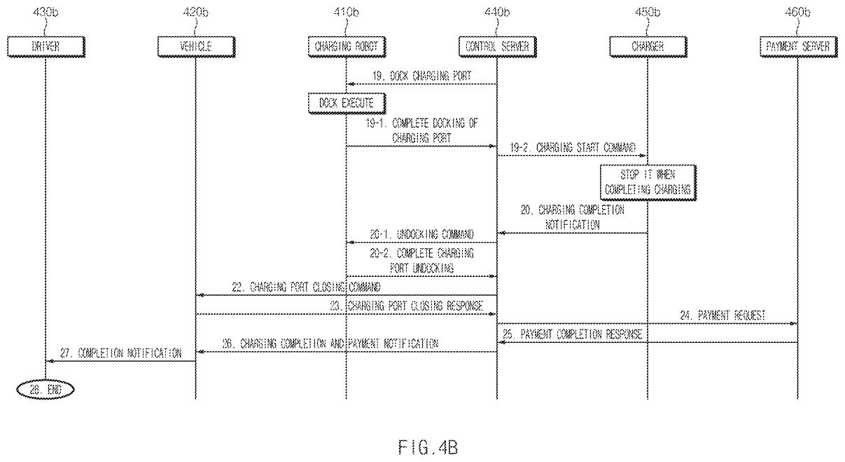

FIGS. 4A and 4B are drawings illustrating operations performed to charging a vehicle or stop charging the vehicle, in a charging robot and a control server according to an embodiment of the present disclosure.

Referring to FIG. 4A, a charging robot 410a according to an embodiment may perform a communication connection with a vehicle 420a. For example, the charging robot 410a may perform a communication connection with the vehicle 420a, based on communication data identified to perform long term evolution (LTE) communication with the vehicle 420a from a control server 440a.

The vehicle 420a may transmit an arrival notification of a charging station and a unique identification key of the vehicle 420a to the charging robot 410a, in response to the communication connection with the charging robot 410a. Herein, the unique identification key may indicate recognition information of the vehicle 420a, which is identified by the charging robot 410a.

The charging robot 410a may deliver the unique identification key of the vehicle 420a and a charging position to the control server 440a, based on receiving the arrival notification and the unique identification key from the vehicle 420a. For example, the charging position may be determined by positions of the charging robot 410a and the vehicle 420a.

The control server 440a may query the vehicle information query server 450a for information of the vehicle 420a, based on receiving the unique identification key and the charging position from the charging robot 410a. When the vehicle 420a is identified by the vehicle information query server 450a, the control server 440a may transmit a charging acknowledgment request to the vehicle 420a.

When the charging acknowledgment request received from the control server 440a is displayed by an AVN system included in the vehicle 420a, a driver 430a may input a response to the charging acknowledgment request. In this case, the vehicle 420a may transmit the response input from the driver 430a to the control server 440a.

The charging robot 410a may determine a position of the vehicle 420a and may ensure charging safety of the vehicle 420a, based on that the response to the charging acknowledgment request is transmitted to the control server 440a by the driver 430a. In detail, the charging robot 410a may identify the vehicle 420a by means of its first position recognition device. When the vehicle 420a is identified by means of the first position recognition device, the charging robot 410a may determine a position of the vehicle 420a, based on a distance between the vehicle 420a and the charging robot 410a, a movement direction of the vehicle 420a, and a movement speed of the vehicle. The charging robot 410a may identify an obstacle by means of its second position recognition device. When the obstacle is identified, the charging robot 410a may ensure charging safety of the vehicle 420a, based on a distance between the obstacle and the vehicle 420a, a movement direction of the obstacle, and a movement speed of the obstacle.

The control server 440a may transmit an acknowledgment request for charging payment information to the vehicle 420a, based on that the position of the vehicle 420a is determined by the charging robot 410a and that the charging safety of the vehicle 420a is ensured by the charging robot 410a. The control server 440a may request the payment server 460a to validate charging payment information, based on receiving the response corresponding to the acknowledgment request for the charging payment information from the vehicle 420a. The control server 440a may transmit charging data of the vehicle 420a (e.g., data about a charging port opening command), based on that the charging payment information is validated.

Referring to FIG. 4B, a charging robot 410b according to an embodiment may couple a charging port of a charger 450b to a charging inlet of a vehicle 420b, based on receiving a command to dock the charging port from a control server 440b. The control server 440b may transmit a charging start command to the charger 450b, based on receiving a response to the completion of the docking of the charging port from the charging robot 410b. Due to such a series of operations, each of the charging robot 410b and the control server 440b may charge the vehicle 420b.

The control server 440b may transmit a payment request to the payment server 460b, based on that the charging of the vehicle 420b is completed and receiving a charging port closing response from the vehicle 420b. Herein, payment information which is a target of a payment request may be recognition information received and obtained by identifying the vehicle 420b.

When receiving a payment completion response from the payment server 460b, the control server 440b may transmit a notification of charging completion and payment completion to the vehicle 420b. Herein, when the notification of the charging completion and the payment completion received from the control server 440b is displayed by an AVN system included in the vehicle 420b, a driver 430b may know that the charging is completed.

FIG. 5 is a drawing illustrating a method for recognizing a vehicle by means of a first position recognition device, in a charging robot according to an embodiment of the present disclosure.

A charging robot 500 according to an embodiment may identify a vehicle by means of a first position recognition device (e.g., a first position recognition device 150 of FIG. 1). For example, the charging robot 500 may determine a distance between the identified vehicle and the charging robot 500, a movement direction of the vehicle, and a movement speed of the vehicle. The charging robot 500 may determine a position of the vehicle, based on the distance between the vehicle and the charging robot 500, the movement direction of the vehicle, and the movement speed of the vehicle. When the determined position of the vehicle is included in a charging position, the charging robot 500 may charge the vehicle.

In detail, the charging robot 500 may determine a position 510 of the vehicle at a target time point, on the basis of a target time point when the vehicle is identified by means of the first position recognition device. For example, the charging robot 500 may determine the position 510 of the vehicle at the target time point, by means of a UWB sensor included in the first position recognition device.

The charging robot 500 may determine a first distance, based on the result of communication between a tag capable of being included in the vehicle and identifying a position of the vehicle and an anchor of the UWB sensor included in the first position recognition device. Herein, the first distance may be a distance between the vehicle and the charging robot 500, which may be a distance different from a second distance which will be described below with reference to FIG. 6.

The charging robot 500 may determine a first movement direction, based on the position 510 of the vehicle at the target time point. The charging robot 500 may determine a first movement speed, based on that the first distance and the first movement direction. In other words, the charging robot 500 may determine the first distance, the first movement direction, and the first movement speed on the basis of the position 510 of the vehicle at the target time point. In detail, the first movement direction may be determined, based on a difference between the position 510 of the vehicle at the target time point and a position of the vehicle at a preceding time point preceding the target time point.

The charging robot 500 may determine a position 520 of the vehicle at a subsequent time point subsequent to the target time point, based on the first distance, the first movement direction, and the first movement speed. In other words, the current position of the vehicle may indicate the position 510 of the vehicle at the target time point. Furthermore, the position of the vehicle after a predetermined time elapses may indicate the position 520 of the vehicle at the subsequent time point, due to a current driving state of the vehicle.

The charging robot 500 may obtain acceleration of the vehicle at the target time point, based on the first distance and the first movement speed. The charging robot 500 may determine the position 520 of the vehicle at the subsequent time point, based on the position 510 of the vehicle at the target time point, the first movement speed at the target time point, the first movement speed at the preceding time point preceding the target time point, and the acceleration of the vehicle at the target time point. In detail, the position 520 of the vehicle at the subsequent time point may be represented by Equation 1 below.

$$( {x}_{t} , {y}_{t} ) = ( x + ( {v}_{x} \times t ) + ( \frac{1}{2} \times {a}_{x} \times {t}^{2} ) , y + ( {v}_{y} \times t ) + ( \frac{1}{2} \times {a}_{y} \times {t}^{2} ) ) \qquad Equation 1$$

Herein, (xₜ,yₜ) may refer to the position 520 of the vehicle at the subsequent time point, (x,y) may refer to the position 510 of the vehicle at the target time point, (vₓ,v_{y}) may refer to the first movement speed at the target time point, (aₓ,a_{y}) may refer to the acceleration of the vehicle at the target time point, t may refer to the predetermined time and may refer to the difference between the subsequent time point and the target time point. Therefore, the position 520 of the vehicle at the subsequent time point may be a predicted position determined based on the position 510 of the vehicle at the target time point identified from the UWB sensor.

The charging robot 500 may transmit a request notification for requesting to move the vehicle, through at least one of an output device included in the charging robot 500 or an output device included in a charging station, or any combination thereof, based on the position 520 of the vehicle at the subsequent time point is located in an area different from a charging area including a charging position.

The charging robot 500 may transmit a request notification for requesting to move the vehicle, based on comparing acceleration (e.g., (aₓ,a_{y})) of the vehicle at the target time point with predetermined acceleration. For example, when the acceleration of the vehicle at the target time point is greater than the predetermined acceleration, the charging robot 500 may transmit a request notification for requesting to move the vehicle, through the output device or the output device included in the charging station, or any combination thereof.

When it is determined that the position 520 of the vehicle at the subsequent time point is included in the charging position, the charging robot 500 may skip the transmission of the request notification for requesting to move the vehicle. Furthermore, the charging robot 500 may identify that the position of the vehicle is located at the charging position, based on comparing the first distance with a predetermined distance available for charging. For example, when the first distance is less than or equal to the predetermined distance available for charging, the charging robot 500 may identify that the position of the vehicle is located at the charging position. The charging robot 500 may charge the vehicle, based on that the position of the vehicle is located at the charging position. Particularly, the charging robot 500 may identify a UWB tag included in the vehicle by means of a UWB anchor included in the first position recognition device, thus more accurately identifying a position of a charging inlet of the vehicle.

Otherwise, the charging robot 500 may transmit a request notification for requesting to move the vehicle, through the output device or the output device included in the charging station, or any combination thereof, based on that it is identified that the position of the vehicle is not located at the charging position. The charging robot 500 may transmit the request notification for requesting to move the vehicle a predetermined number of times, but not limited thereto. For example, when identifying that the vehicle moves to the charging position, the charging robot 500 may stop the request notification for requesting to move the vehicle.

FIG. 6 is a drawing illustrating a method for recognizing an obstacle by means of a second position recognition device, in a charging robot according to an embodiment of the present disclosure.

A charging robot 600 according to an embodiment may stop charging a vehicle 640, at the same time as charging the vehicle 640. For example, the charging robot 600 may identify an obstacle located around the vehicle 640, by means of a second position recognition device (e.g., a second position recognition device 160 of FIG. 1). When identifying the obstacle, the charging robot 600 may stop charging the vehicle 640. Furthermore, when identifying that a door of the vehicle 640 is open by means of the second position recognition device, the charging robot 600 may stop charging the vehicle 640.

The charging robot 600 may determine a safe area 610 corresponding to an identification area of the second position recognition device, based on the position of the vehicle 640 is a charging position. Herein, the charging robot 600 may determine at least one of a second distance between the obstacle identified by means of the second position recognition device and the vehicle 640, a second movement direction of the obstacle, or a second movement speed of the obstacle, or any combination thereof, based on that the position of the obstacle is located in the safe area 610. However, it is not limited thereto. For example, the charging robot 600 may determine at least one of the second distance, the second movement direction, or the second movement speed, or any combination thereof, based on that the position of the obstacle is a position spaced apart from the safe area 610 at a predetermined distance or is located in the safe area 610.

For example, the charging robot 600 may stop charging the vehicle 640, based on the at least one of the second distance, the second movement direction, or the second movement speed, or the any combination thereof. For example, the charging robot 600 may identify an external obstacle 620 and an internal obstacle 630. The charging robot 600 may determine the second distance, the second movement direction and the second movement speed of each of the external obstacle 620 and the internal obstacle 630.

First of all, when the charging robot 600 identifies the external obstacle 620, operations performed by the charging robot 600 will be described below. When identifying the external obstacle 620, the charging robot 600 may stop charging the vehicle 640. The charging robot 600 may obtain the second distance, the second movement direction, and the second movement speed of the external obstacle 620. The charging robot 600 may skip the stop of the charging of the vehicle 640 and may charge the vehicle 640, based on that the second movement speed of the external obstacle 620 is less than or equal to a predetermined first threshold speed. In other words, when the second movement speed of the external obstacle 620 is less than or equal to the first threshold speed, the charging robot 600 may continue charging the vehicle 640.

Otherwise, the charging robot 600 may completely stop charging the vehicle 640, based on that the second movement speed of the external obstacle 620 is greater than or equal to a predetermined second threshold speed and that the second movement direction corresponds to a direction of the position of the vehicle 640 from the position of the external obstacle 620. In this case, the charging robot 600 may transmit an alarm for stopping charging the vehicle 640 through at least one of its output device or an output device included in a charging station, or any combination thereof.

Next, when the charging robot 600 identifies the internal obstacle 630, operations performed by the charging robot 600 will be described below. When identifying the internal obstacle 630, the charging robot 600 may immediately stop charging the vehicle 640. The charging robot 600 may transmit an alarm for stopping charging the vehicle 640 through at least one of the output device or the output device included in the charging station, or any combination thereof. Furthermore, the charging robot 600 may transmit an alarm for removing the internal obstacle 630 from a safe area 610 through at least one of the output device or the output device included in the charging station, or any combination thereof.

The charging robot 600 may identify recognition information including information of the vehicle 640, by means of a LiDAR sensor included in the second position recognition device. In other words, the charging robot 600 may identify the recognition information including the information of the vehicle 640, as well as recognizing the obstacle, by means of the second position recognition device. The charging robot 600 may identify the vehicle 640 by means of the second position recognition device and may immediately stop charging the vehicle 640, based on that it is identified that the door of the vehicle 640 is open.

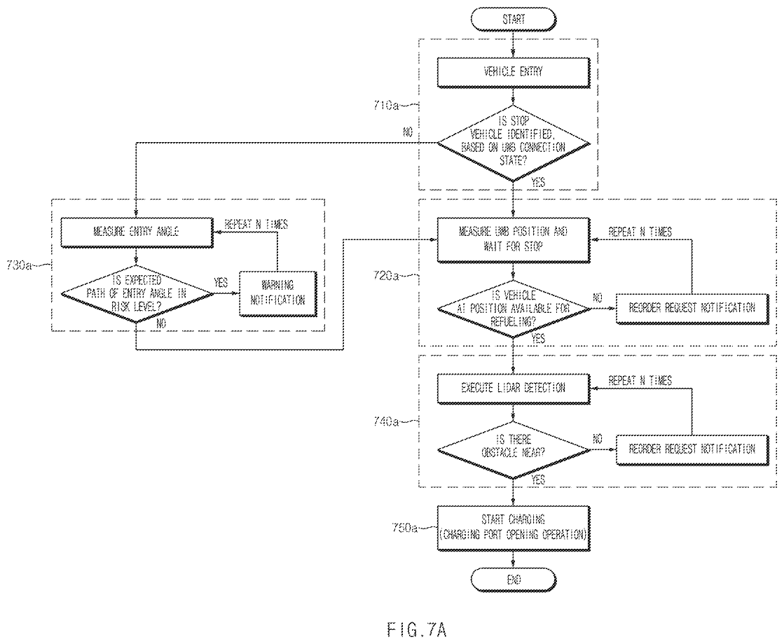

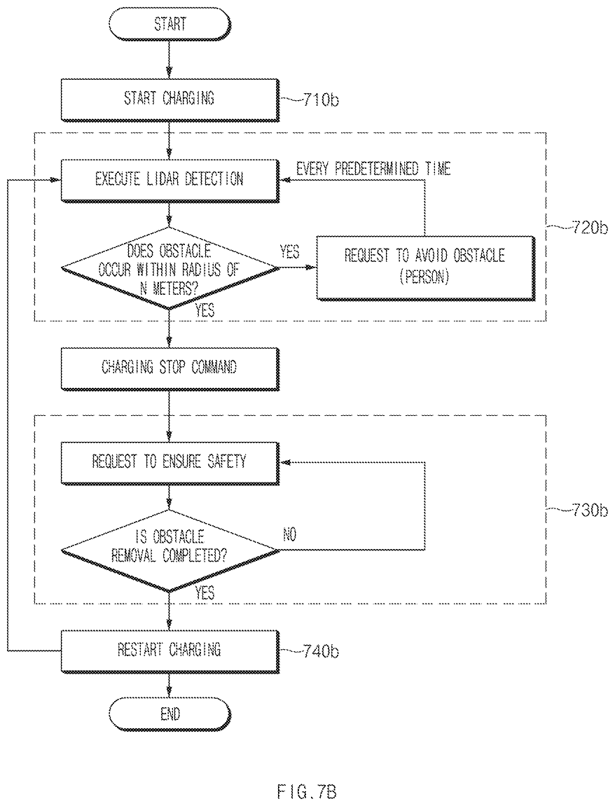

FIGS. 7A and 7B are flowcharts for describing operations performed to charging a vehicle or stop charging the vehicle, in a charging robot and a control server according to an embodiment of the present disclosure.

Referring to FIG. 7A, in operation 710a, a charging robot (e.g., a charging robot 100 of FIG. 1) according to an embodiment may identify a UWB connection, when a vehicle enters a charging station. For example, the charging robot may identify a UWB connection to identify the vehicle by means of its first position recognition device.

In operation 720a, the charging robot may determine whether the vehicle is located at a position available for refueling (or charging). When the vehicle is not located at the position available for refueling, the charging robot may transmit a reorder request notification. For example, in operation 730a, the charging robot may obtain an entry angle of the vehicle. In detail, the charging robot may determine a first movement direction from positions of the vehicle. The charging robot may obtain an entry angle of the vehicle by means of a change in the first movement directions. The charging robot may determine whether an expected path of the vehicle is in a risk level, by means of the entry angle of the vehicle. When the expected path of the vehicle is in the risk level, the charging robot may transmit a warning notification.

In operation 740a, the charging robot may identify an obstacle located around the vehicle which is being charged, by means of its second position recognition device. For example, the charging robot may identify an obstacle located around the vehicle which is being charged, by means of a LiDAR sensor included in the second position recognition device.

When the vehicle is located at a position available for refueling (or charging) and when there is no obstacle around the vehicle, in operation 750a, the charging robot may charge the vehicle.

Referring to FIG. 7B, when the vehicle is located at a position available for refueling (or charging) and when there is no obstacle around the vehicle, in operation 710b, the charging robot according to an embodiment may perform charging of the vehicle.

In operation 720b, the charging robot may identify an obstacle around the vehicle, during a time when the charging is performed. For example, the charging robot may identify an obstacle located around the vehicle which is being charged, by means of the LiDAR sensor included in the second position recognition device, every predetermined time. In detail, the charging robot may transmit a request to avoid an external obstacle identified out of a safe area which is a predetermined area. Otherwise, when an internal obstacle is identified in the safe area which is the predetermined area, the charging robot may immediately stop charging the vehicle.

In operation 730b, the charging robot may transmit an alarm about a request to ensure safety, through at least one of the output device or the output device included in the charging station, or any combination thereof, for the identified internal obstacle.

In operation 740b, the charging robot may charge the vehicle again, when the removal of the identified internal obstacle is completed.

FIG. 8 is a drawing illustrating information capable of being displayed in a vehicle, as a charging robot transmits charging data to the vehicle, according to an embodiment of the present disclosure.

A charging robot 800 according to an embodiment may include a UWB sensor and a LiDAR sensor. The charging robot 800 may identify a movement process and a movement path of a vehicle 810 by means of the UWB sensor. The charging robot 800 may identify an obstacle located around the vehicle 810 which is being charged, by means of the LiDAR sensor. In detail, the charging robot 800 may identify an obstacle inside and outside a safe area 820 by means of the LiDAR sensor.

The charging robot 800 may transmit recognition information for identifying the vehicle to a control server (e.g., a control server 330 of FIG. 3). The control server may identify communication data for performing long term evolution (LTE) communication with the vehicle 810, based on that information of the vehicle 810 is queried by means of the received recognition information. The control server may transmit charging data, received from the charging robot 800, to the vehicle 810, based on the communication data.

The vehicle 810 may include an AVN system capable of receiving an input of a driver. The vehicle 810 may provide the driver with payment about charging, by means of the AVN system. For example, the vehicle 810 may provide the driver with the charging data received from the control server through the AVN system, thus obtaining payment approval of the driver. When arriving at a charging station, the driver may click on a confirm button on a pop-up window output from the AVN system to charge the vehicle, without executing a separate application or manipulating the AVN system.

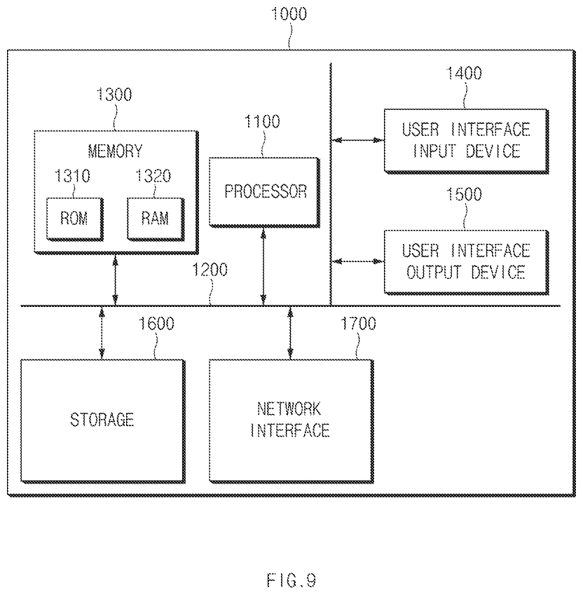

FIG. 9 is a drawing illustrating a computing system associated with a charging robot, a control server, or a charging method according to an embodiment of the present disclosure.

Referring to FIG. 9, a computing system 1000 about the charging robot, the control server, or the charging method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

The above-described embodiments may be implemented with hardware components, software components, and/or a combination of hardware components and software components. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit may perform an operating system (OS) or a software application running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one computer-readable storage media.

The methods according to embodiments may be implemented in the form of program instructions which may be executed through various computer means and may be recorded in computer-readable media. The computer-readable media may include program instructions, data files, data structures, and the like alone or in combination, and the program instructions recorded on the media may be specially designed and configured for an example or may be known and usable to those skilled in the art of computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

The above-described hardware devices may be configured to act as one or a plurality of software modules to perform the operations of the embodiments, or vice versa.

Even though the embodiments are described with reference to restricted drawings, it may be obviously to one skilled in the art that the embodiments are variously changed or modified based on the above description. For example, adequate effects may be achieved even if the foregoing processes and methods are carried out in different order than described above, and/or the aforementioned components, such as systems, structures, devices, or circuits, are combined or coupled in different forms and modes than as described above or be substituted or switched with other components or equivalents.

A description will be given of effects of the charging robot, the control server, and the charging method according to an embodiment of the present disclosure.

According to at least one of embodiments of the present disclosure, the charging robot may charge the vehicle based on that the position of the vehicle identified by means of a first position recognition device is included in a charging position and may determine an entry speed and an expected position of the vehicle which moves for charging, without the necessity of a CCTV for identifying a parking state of the vehicle, thus preventing an accident through a warning alarm.

Furthermore, according to at least one of embodiments of the present disclosure, the charging robot may stop charging the vehicle based on that the position of an obstacle identified by means of a second position recognition device is located in a safe area, thus increasing economic efficiency because there is no need to install a separate motion sensor bollard for obstacle detection for identifying an obstacle.

Furthermore, according to at least one of embodiments of the present disclosure, the charging robot may transmit charging data to the vehicle, based on communication data identified by means of recognition information for identifying the vehicle, thus increasing efficiency because there is no need to install a separate application by using convenience capable of paying a charging fee without the alighting of the driver and an audio, video, navigation (AVN) system included in the vehicle.

In addition, various effects ascertained directly or indirectly through the present disclosure may be provided.

Therefore, other implements, other embodiments, and equivalents to claims are within the scope of the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

1. A charging robot, comprising:
a memory storing computer-executable instructions;
at least one processor configured to access the memory and execute the computer-executable instructions;
an output device; and
a first position recognition device configured to identify a vehicle approaching a charging specification;
wherein the at least one processor is configured to:
determine at least one of a first distance between the vehicle identified by the first position recognition device and the charging robot, a first movement direction of the vehicle, or a first movement speed of the vehicle, or any combination thereof; and
charge the vehicle, when a position of the vehicle is included in a charging position which is a position at which the charging robot is able to charge the vehicle, based on at least one of the first distance, the first movement direction, or the first movement speed, or any combination thereof.

2. The charging robot of claim 1, wherein the at least one processor is further configured to:
determine the first distance, based on a result of communication between a tag capable of being included in the vehicle and identifying the position of the vehicle, and an anchor of an ultra-wideband (UWB) sensor included in the first position recognition device, based on a target time point when the vehicle is identified by the first position recognition device;
determine the first movement direction, based on the position of the vehicle; and
determine the first movement speed, based on the first distance and the first movement direction.

3. The charging robot of claim 2, wherein the at least one processor is further configured to:
determine a position of the vehicle at a subsequent time point subsequent to the target time point, based on a position of the vehicle at the target time point when the vehicle is identified by the first position recognition device, a first movement speed at the target time point, a first movement speed of a preceding time point preceding the target time point, and acceleration of the vehicle at the target time point; and
transmit a request notification for requesting to move the vehicle, through at least one of the output device or a second output device included in a charging station, or any combination thereof, when a position of the vehicle at the subsequent time point is located in an area different from a charging area including the charging position.

4. The charging robot of claim 2, wherein the at least one processor is further configured to:
transmit a request notification for requesting to move the vehicle, through at least one of the output device or a second output device included in a charging station, or any combination thereof, based on comparing an acceleration of the vehicle at the target time point with a predetermined acceleration.

5. The charging robot of claim 1, wherein the at least one processor is further configured to:
identify when the position of the vehicle is located at the charging position, based on comparing the first distance with a predetermined distance available for charging; and
charge the vehicle, when the position of the vehicle is located at the charging position.

6. The charging robot of claim 5, wherein the at least one processor is further configured to:
transmit a request notification for requesting to move the vehicle, through at least one of the output device or a second output device included in a charging station, or any combination thereof, when it is identified that the position of the vehicle is not located at the charging position.

7. The charging robot of claim 1, further comprising:
a second position recognition device configured to identify an obstacle located in a predetermined area based on the position of the vehicle,
wherein the at least one processor is further configured to:
determine a safe area corresponding to an identification area of the second position recognition device, when the position of the vehicle is included in the charging position;
determine at least one of a second distance between the obstacle identified by the second position recognition device and the vehicle, a second movement direction of the obstacle, or a second movement speed of the obstacle, or any combination thereof, when a position of the obstacle is located in the safe area; and
stop charging the vehicle, based on at least one of the second distance, the second movement direction, or the second movement speed, or the any combination thereof.

8. The charging robot of claim 7, wherein the at least one processor is further configured to:
identify recognition information including information of the vehicle, by a light detection and ranging (LiDAR) sensor included in the second position recognition device.

9. The charging robot of claim 7, wherein the at least one processor is further configured to:
skip the stop of the charging of the vehicle and charge the vehicle, when the second movement speed is less than or equal to a predetermined first threshold speed.

10. The charging robot of claim 7, wherein the at least one processor is further configured to:
stop charging the vehicle, when the second movement speed is greater than or equal to a predetermined second threshold speed, and when the second movement direction corresponds to a direction of the position of the vehicle from the position of the obstacle; and
transmit a stop notification for stopping charging the vehicle, through at least one of the output device or a second output device included in a charging station, or any combination thereof.

11. The charging robot of claim 7, wherein the at least one processor is further configured to:
identify the vehicle by the second position recognition device; and
stop charging the vehicle, when it is identified that a door of the vehicle is open.

12. A control server, comprising:
a memory storing computer-executable instructions;
at least one processor configured to access the memory and to execute the instructions; and
a communication device configured to communicate with a charging robot and a vehicle;
wherein the at least one processor is configured to:
receive recognition information for identifying the vehicle, from the charging robot;
identify communication data for performing long term evolution (LTE) communication with the vehicle, based on whether the information for identifying the vehicle is queried by the received recognition information; and
transmit charging data, received from the charging robot, to the vehicle, based on the communication data.

13. A charging method, comprising:
determining at least one of a first distance between a vehicle identified by a first position recognition device included in a charging robot and the charging robot, a first movement direction of the vehicle, or a first movement speed of the vehicle, or any combination thereof;
charging the vehicle, based on whether a position of the vehicle is included in a charging position which is a position at which the charging robot is able to charge the vehicle, based on at least one of the first distance, the first movement direction, or the first movement speed, or any combination thereof;
determining a safe area corresponding to an identification area of a second position recognition device included in the charging robot, when the position of the vehicle is included in the charging position;
determining at least one of a second distance between an obstacle identified by the second position recognition device and the vehicle, a second movement direction of the obstacle, or a second movement speed of the obstacle, or any combination thereof, when a position of the obstacle is located in the safe area; and
stopping charging the vehicle, based on at least one of the second distance, the second movement direction, or the second movement speed, or any combination thereof.

14. The charging method of claim 13, wherein the charging of the vehicle includes:
determining the first distance, based on a result of communication between a tag capable of being included in the vehicle and identifying the position of the vehicle and an anchor of an ultra-wideband (UWB) sensor included in the first position recognition device, based on a target time point when the vehicle is identified by the first position recognition device;
determining the first movement direction, based on the position of the vehicle;
determining the first movement speed, based on the first distance and the first movement direction;
determining a position of the vehicle at a subsequent time point subsequent to the target time point, based on a position of the vehicle at the target time point when the vehicle is identified by the first position recognition device, a first movement speed at the target time point, a first movement speed of a preceding time point preceding the target time point, and acceleration of the vehicle at the target time point; and
transmitting a request notification for requesting to move the vehicle, through at least one of an output device included in the charging robot or a second output device included in a charging position, or any combination thereof, when the position of the vehicle at the subsequent time point is located in an area different from a charging area including the charging position.

15. The charging method of claim 14, wherein the transmitting of the request notification for requesting to move the vehicle includes:
transmitting the request notification for requesting to move the vehicle, through at least one of the output device or the second output device included in the charging station, or any combination thereof, based on comparing the acceleration of the vehicle at the target time point with a predetermined acceleration.

16. The charging method of claim 13, wherein the charging of the vehicle includes:
identifying that the position of the vehicle is located at the charging position, based on comparing the first distance with a predetermined distance available for charging;
charging the vehicle, when the position of the vehicle is located at the charging position; and
transmitting a request notification for requesting to move the vehicle, through at least one of an output device included in the charging robot or a second output device included in a charging station, or any combination thereof, when it is identified that the position of the vehicle is not located at the charging position.

17. The charging method of claim 13, wherein the stopping of the charging of the vehicle includes:
skipping the stop of the charging of the vehicle and charging the vehicle, when the second movement speed is less than or equal to a predetermined first threshold speed.

18. The charging method of claim 13, wherein the stopping of the charging of the vehicle includes:
stopping charging the vehicle, when the second movement speed is greater than or equal to a predetermined second threshold speed, and when the second movement direction corresponds to a direction of the position of the vehicle from the position of the obstacle; and
transmitting a stop notification for stopping charging the vehicle, through at least one of an output device included in the charging robot or a second output device included in a charging station, or any combination thereof.

19. The charging method of claim 13, wherein the stopping of the charging of the vehicle includes:
identifying the vehicle by the second position recognition device; and
stopping charging the vehicle, when it is identified that a door of the vehicle is open.

20. The charging method of claim 13, further comprising:
receiving recognition information for identifying the vehicle from the charging robot;
identifying communication data for performing long term evolution (LTE) communication with the vehicle, when information of the vehicle is queried by the received recognition information; and
transmitting charging data, received from the charging robot, to the vehicle, based on the communication data.
